(19) United States
(12) Patent Application Publication
(10) Pub. No.: US 2019/0391835 A1
(43) Pub. Date: Dec. 26, 2019

(54) SYSTEMS AND METHODS FOR MIGRATION OF COMPUTING RESOURCES BASED ON INPUT/OUTPUT DEVICE PROXIMITY

(71) Applicant: Dell Products L.P., Round Rock, TX (US)

(72) Inventors: Srinivas Giri Raju GOWDA, Santa Clara, CA (US); Mukund P. KHATRI, Austin, TX (US)

(73) Assignee: Dell Products L.P., Round Rock, TX (US)

(21) Appl. No.: 16/018,896

(22) Filed: Jun. 26, 2018

(51) Int. Cl. G06F 9/455; G06F 13/10

(52) U.S. Cl. CPC G06F 9/45558; G06F 2009/45579; G06F 2009/4557; G06F 13/102

(57) ABSTRACT

In accordance with embodiments of the present disclosure, an information handling system may include a plurality of host systems and a hypervisor manager comprising a program of instructions configured to, when read and executed by a processor of one of the plurality of host systems, in response to a command for migrating a computing resource executing on one of the plurality of host systems, select a host system as a target for migrating the computing resource based on a proximity of input/output devices of the host system with respect to a proximity domain of the host system, and migrate the computing resource to the host system selected as the target.

### TECHNICAL FIELD

The present disclosure relates in general to information handling systems, and more particularly to methods and systems for migration of computing resources based on input/output device proximity in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In many computing applications, an information handling system includes a hypervisor for hosting one or more virtual machines. A hypervisor may comprise software and/or firmware generally operable to allow multiple virtual machines and/or operating systems to run on a single information handling system at the same time. This operability is generally allowed via virtualization, a technique for hiding the physical characteristics of computing system resources (e.g., physical hardware of the computing system) from the way in which other systems, applications, or end users interact with those resources. Thus, a virtual machine may comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In many instances, it may be desirable or needed to move the execution of a virtual machine from one hardware resource to another hardware resource (e.g., from one processor or processor core to another processor or processor core) or from one hypervisor to another hypervisor. Using existing approaches, migration of virtual machines may be driven by several different migration policies. For example, for a successful virtual machine migration, adequate hardware resources (processing capacity, memory capacity, input/output capacity) may be required to be available. As another example, migration of virtual machines may also or alternatively have software-driven policies or requirements (e.g., network utilization) that govern virtual machine migration.

From a virtual machine's perspective, migrating to a different host results in no changes to its runtime virtualized environment. However, the same may not apply to the hardware and software platforms that host a migrating virtual machine. For example, if a virtual machine's processing and input/output resources are in different proximity domains (e.g., different Non-Uniform Memory Access input/output or NUMA I/O domains), performance of the virtual machine may be negatively affected by input/output latency and reduced throughput.

### SUMMARY

In accordance with the teachings of the present disclosure, the disadvantages and problems associated with existing approaches to migration of virtual machines and other computing resources within an information handling system may be reduced or eliminated.

In accordance with these and other embodiments of the present disclosure, a method comprising, in an information handling system comprising a plurality of host systems, in response to a command for migrating a computing resource executing on one of the plurality of host systems, selecting a host system as a target for migrating the computing resource based on a proximity of input/output devices of the host system with respect to a proximity domain of the host system, and migrating the computing resource to the host system selected as the target.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, in an information handling system comprising a plurality of host systems, in response to a command for migrating a computing resource executing on one of the plurality of host systems, selecting a host system as a target for migrating the computing resource based on a proximity of input/output devices of the host system with respect to a proximity domain of the host system, and migrating the computing resource to the host system selected as the target.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2 illustrates a block diagram of selected components of an example information handling system and proximity domains which include such components, in accordance with embodiments of the present disclosure; and

FIG. 3 illustrates a flow chart of an example method for migration of computing resources based on input/output device proximity, in accordance with embodiments of the present disclosure.

### DETAILED DESCRIPTION

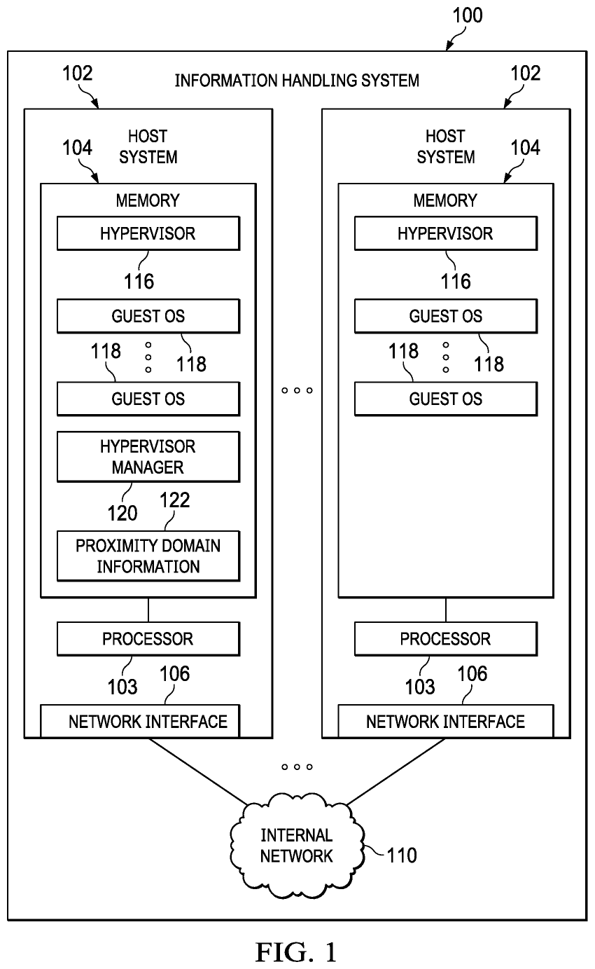

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of selected components of an example information handling system 100 having a plurality of host systems 102, in accordance with embodiments of the present disclosure. As shown in FIG. 1, information handling system 100 may include a plurality of host system 102 coupled to one another via an internal network 110.

In some embodiments, a host system 102 may comprise a server (e.g., embodied in a “sled” form factor). In these and other embodiments, a host system 102 may comprise a personal computer. In other embodiments, a host system 102 may be a portable computing device (e.g., a laptop, notebook, tablet, handheld, smart phone, personal digital assistant, etc.). As depicted in FIG. 1, information handling system 102 may include a processor 103, a memory 104 communicatively coupled to processor 103, and a network interface 106 communicatively coupled to processor 103. For the purposes of clarity and exposition, in FIG. 1, each host system 102 is shown as comprising only a single processor 103, single memory 104, and single network interface 106. However, a host system 102 may comprise any suitable number of processors 103, memories 104, and network interfaces 106.

A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a memory 104 and/or other computer-readable media accessible to processor 103.

A memory 104 may be communicatively coupled to a processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, a memory 104 may have stored thereon a hypervisor 116 and one or more guest operating systems (OS) 118. In some embodiments, hypervisor 116 and one or more of guest OSes 118 may be stored in a computer-readable medium (e.g., a local or remote hard disk drive) other than a memory 104 which is accessible to processor 102.

A hypervisor 116 may comprise software and/or firmware generally operable to allow multiple virtual machines and/or operating systems to run on a single computing system (e.g., an information handling system 102) at the same time. This operability is generally allowed via virtualization, a technique for hiding the physical characteristics of computing system resources (e.g., physical hardware of the computing system) from the way in which other systems, applications, or end users interact with those resources. A hypervisor 116 may be one of a variety of proprietary and/or commercially available virtualization platforms, including without limitation, VIRTUALLOGIX VLX FOR EMBEDDED SYSTEMS, IBM's Z/VM, XEN, ORACLE VM, VMWARE's ESX SERVER, L4 MICROKERNEL, TRANGO, MICROSOFT's HYPER-V, SUN's LOGICAL DOMAINS, HITACHI's VIRTAGE, KVM, VMWARE SERVER, VMWARE WORKSTATION, VMWARE FUSION, QEMU, MICROSOFT's VIRTUAL PC and VIRTUAL SERVER, INNOTEK's VIRTUALBOX, and SWSOFT's PARALLELS WORKSTATION and PARALLELS DESKTOP.

In one embodiment, a hypervisor 116 may comprise a specially-designed OS with native virtualization capabilities. In another embodiment, a hypervisor 116 may comprise a standard OS with an incorporated virtualization component for performing virtualization.

In another embodiment, a hypervisor 116 may comprise a standard OS running alongside a separate virtualization application. In this embodiment, the virtualization application of the hypervisor 116 may be an application running above the OS and interacting with computing system resources only through the OS. Alternatively, the virtualization application of a hypervisor 116 may, on some levels, interact indirectly with computing system resources via the OS, and, on other levels, interact directly with computing system resources (e.g., similar to the way the OS interacts directly with computing system resources, or as firmware running on computing system resources). As a further alternative, the virtualization application of a hypervisor 116 may, on all levels, interact directly with computing system resources (e.g., similar to the way the OS interacts directly with computing system resources, or as firmware running on computing system resources) without utilizing the OS, although still interacting with the OS to coordinate use of computing system resources.

As stated above, a hypervisor 116 may instantiate one or more virtual machines. A virtual machine may comprise any program of executable instructions, or aggregation of programs of executable instructions, configured to execute a guest OS 118 in order to act through or in connection with a hypervisor 116 to manage and/or control the allocation and usage of hardware resources such as memory, CPU time, disk space, and input and output devices, and provide an interface between such hardware resources and application programs hosted by the guest OS 118. In some embodiments, a guest OS 118 may be a general-purpose OS such as WINDOWS or LINUX, for example. In other embodiments, a guest OS 118 may comprise a specific- and/or limited-purpose OS, configured so as to perform application-specific functionality (e.g., persistent storage).

At least one information handling system 102 in system 100 may have stored within its memory 104 a hypervisor manager 120. A hypervisor manager 120 may comprise software and/or firmware generally operable to manage individual hypervisors 120 and the guest OSes 118 instantiated on each hypervisor 116, including controlling migration of guest OSes 118 between hypervisors 116.

At least one information handling system 102 in system 100 may have stored within its memory 104 proximity domain information 122. Proximity domain information 122 may comprise a table, list, array, or other suitable data structure including one or more entries, wherein the entries set forth information regarding proximity domains of information handling system 100 and the various information handling resources present within such proximity domain. For example, in some embodiments, proximity domain information 122 may include NUMA I/O proximity domain information as set forth in an Advanced Configuration and Power Interface (ACPI) table.

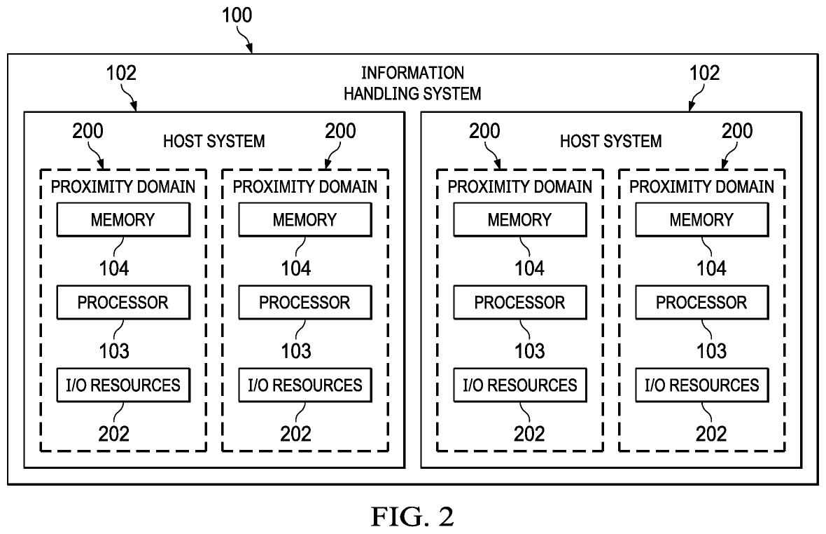

Turning briefly to FIG. 2, FIG. 2 illustrates a block diagram of selected components of example information handling system 100 and proximity domains 200 which include such components, in accordance with embodiments of the present disclosure. As shown in FIG. 2, each proximity domain (e.g., NUMA I/O proximity domain) may include a processor 103, a memory (or memories) 104 associated with such processor 103, input/output (I/O) resources 202 (e.g., persistent storage, storage-class memories, and/or I/O devices other than storage and memory) associated with such processor 103, and one or more other information handling resources associated with such processor 103. Although FIG. 2 shows a multi-processor (e.g., multi-socketed) information handling system, in some embodiments, the systems and methods disclosed herein may be applied to a single-processor information handling system that includes multiple proximity domains (e.g., the single processor exists in multiple domains, wherein each domain has its own memory and I/O resources).

Returning again to FIG. 1, a network interface 106 may include any suitable system, apparatus, or device operable to serve as an interface between an associated information handling system 102 and internal network 110. A network interface 106 may enable its associated information handling system 102 to communicate with internal network 110 using any suitable transmission protocol (e.g., TCP/IP) and/or standard (e.g., IEEE 802.11, Wi-Fi). In certain embodiments, a network interface 106 may include a physical NIC. In the same or alternative embodiments, a network interface 106 may be configured to communicate via wireless transmissions. In the same or alternative embodiments, a network interface 106 may provide physical access to a networking medium and/or provide a low-level addressing system (e.g., through the use of Media Access Control addresses). In some embodiments, a network interface 106 may be implemented as a local area network (“LAN”) on motherboard (“LOM”) interface. A network interface 106 may comprise one or more suitable network interface cards, including without limitation, mezzanine cards, network daughter cards, etc.

Internal network 110 may be a network and/or fabric configured to communicatively couple information handling systems to each other. In certain embodiments, internal network 110 may include a communication infrastructure, which provides physical connections, and a management layer, which organizes the physical connections of host systems 102 and other devices coupled to internal network 110. Internal network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Internal network 110 may transmit data using any storage and/or communication protocol, including without limitation, Fibre Channel, Fibre Channel over Ethernet (FCoE), Small Computer System Interface (SCSI), Internet SCSI (iSCSI), Frame Relay, Ethernet Asynchronous Transfer Mode (ATM), Internet protocol (IP), or other packet-based protocol, and/or any combination thereof. Network 110 and its various components may be implemented using hardware, software, or any combination thereof.

In addition to processor 103, memory 104, and network interface 106, a host system 102 may include one or more other information handling resources.

In operation, as described in more detail below, hypervisor manager 120 may be configured to use proximity domain information to influence migration policy in the virtualized computing environment of information handling system 100.

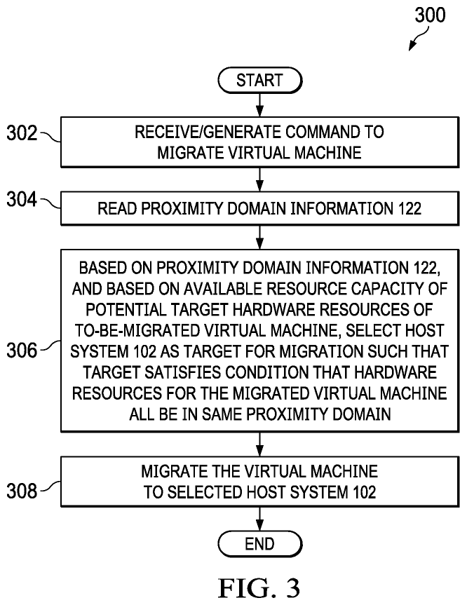

FIG. 3 illustrates a flow chart of an example method 300 for migration of computing resources based on input/output device proximity, in accordance with embodiments of the present disclosure. According to some embodiments, method 300 may begin at step 302 and may be implemented in a variety of configurations of information handling system 100. As such, the preferred initialization point for method 300 and the order of the steps comprising method 300 may depend on the implementation chosen.

At step 302, a command to migrate a virtual machine may be received or generated by hypervisor manager 120. For example, in some instances, hypervisor manager 120 may receive a request from an information technology administrator or other user of information handing system 100 to migrate a virtual machine. In other instances, hypervisor manager 120 may automatically determine that a virtual machine should be migrated (e.g., based on telemetry data regarding resource usage by the virtual machine).

At step 304, hypervisor manager 120 may read proximity domain information 122. At step 306, based on proximity domain information 122, and based on available resource capacity of potential target hardware resources (e.g., processing resources, memory resources, and I/O resources) of the to-be-migrated virtual machine, hypervisor manager 120 may select a host system 102 as a target for migration such that the target can satisfy a condition that the hardware resources (e.g., processing resources, memory resources, and I/O resources) for the migrated virtual machine all be in the same proximity domain. At step 308, hypervisor manager 120 may migrate the virtual machine to selected host system 102.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 100 or any other system operable to implement method 300. In certain embodiments, method 300 may be implemented partially or fully in software and/or firmware embodied in computer-readable media.

Applying the systems and methods disclosed herein, when it is desired to migrate a virtual machine, hypervisor manager 120 identifies a target host system 102 that has both: (a) sufficient processing and memory resource headroom for the virtual machine to be migrated, and (b) the required I/O resources within the same proximity domain as the processing and memory resources as identified in (a). Under existing approaches, if two of more host systems satisfied first condition (a), any of such two or more host systems may be selected as a migration target for a virtual machine. However, the systems and methods disclosed herein for application of the second condition (b), which may give preference for the selected migration target based on domain proximity.

Although the foregoing methods and systems contemplate migration of virtual machines based on input/output device proximity, it is understood that such foregoing methods and systems may be applied to any and all suitable computing resources, including computing resources other than virtual machines (e.g., application programs, dockers, containers, etc.).

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An information handling system comprising:
a plurality of host systems; and
a hypervisor manager comprising a program of instructions configured to, when read and executed by a processor of one of the plurality of host systems:
in response to a command for migrating a computing resource executing on one of the plurality of host systems, select a host system as a target for migrating the computing resource based on a proximity of input/output devices of the host system with respect to a proximity domain of the host system; and
migrate the computing resource to the host system selected as the target.

2. The information handling system of claim 1, wherein selecting the host system selected as the target comprises selecting the host system selected as the target such that the host system selected as the target satisfies a condition that the input/output devices and processing resources for the computing resource after migration are within a single proximity domain.

3. The information handling system of claim 2, wherein the single proximity domain comprises a Non-Uniform Memory Access domain and input/output devices of such Non-Uniform Memory Access domain.

4. The information handling system of claim 2, wherein selecting the host system selected as the target comprises reading proximity domain information for hardware resources of the information handling system.

5. The information handling system of claim 1, wherein the computing resource comprises a virtual machine.

6. A method comprising, in an information handling system comprising a plurality of host systems:
in response to a command for migrating a computing resource executing on one of the plurality of host systems, selecting a host system as a target for migrating the computing resource based on a proximity of input/output devices of the host system with respect to a proximity domain of the host system; and
migrating the computing resource to the host system selected as the target.

7. The method of claim 6, wherein selecting the host system selected as the target comprises selecting the host system selected as the target such that the host system selected as the target satisfies a condition that the input/output devices and processing resources for the computing resource after migration are within a single proximity domain.

8. The method of claim 7, wherein the single proximity domain comprises a Non-Uniform Memory Access domain and input/output devices of such Non-Uniform Memory Access domain.

9. The method of claim 7, wherein selecting the host system selected as the target comprises reading proximity domain information for hardware resources of the information handling system.

10. The method of claim 6, wherein the computing resource comprises a virtual machine.

11. An article of manufacture comprising:
a non-transitory computer-readable medium; and
computer-executable instructions carried on the computer-readable medium, the instructions readable by a processor, the instructions, when read and executed, for causing the processor to, in an information handling system comprising a plurality of host systems:
in response to a command for migrating a computing resource executing on one of the plurality of host systems, selecting a host system as a target for migrating the computing resource based on a proximity of input/output devices of the host system with respect to a proximity domain of the host system; and
migrating the computing resource to the host system selected as the target.

12. The article of claim 11, wherein selecting the host system selected as the target comprises selecting the host system selected as the target such that the host system selected as the target satisfies a condition that the input/output devices and processing resources for the computing resource after migration are within a single proximity domain.

13. The article of claim 12, wherein the single proximity domain comprises a Non-Uniform Memory Access domain and input/output devices of such Non-Uniform Memory Access domain.

14. The article of claim 12, wherein selecting the host system selected as the target comprises reading proximity domain information for hardware resources of the information handling system.

15. The article of claim 11, wherein the computing resource comprises a virtual machine.
